(19) United States
(12) Patent Application Publication
(10) Pub. No.: US 2020/0191238 A1
(43) Pub. Date: Jun. 18, 2020

(54) Belt

(71) Applicant: ContiTech Antriebssysteme GmbH, Hannover (DE)

(72) Inventors: Hubert Goeser, Dannenberg (DE); Jan-Henning Quass, Bergen (DE); Andre Kucharczyk, Guelden (DE); Rolf Marwede, Hannover (DE); Stephan Brocke, Hamburg (DE)

(73) Assignee: ContiTech Antriebssysteme GmbH, Hannover (DE)

(21) Appl. No.: 16/714,851

(22) Filed: Dec. 16, 2019

(30) Foreign Application Priority Data
Dec. 17, 2018 (DE) 10 2018 221 886.2

(51) Int. Cl. F16G 1/10; F16G 1/28

(52) U.S. Cl. CPC F16G 1/10; B29D 29/08; F16G 1/28

(57) ABSTRACT

The present invention concerns a belt (1), with a belt body (10) which extends substantially in a longitudinal direction and substantially comprises a flexible material, wherein at least one tensioning member (13), preferably a plurality of tensioning members (13), is at least substantially embedded in the belt body (10) in the longitudinal direction and at least substantially surrounded by the flexible material of the belt body (10), and with a coating (14) which is arranged directly on the belt body (10) from a drive side (11) of the belt (1), wherein the coating (14) comprises a fabric layer (14b). The belt (1) is characterized in that facing the belt body (10), the coating (14) has a first film (14a) which is arranged between the belt body (10) and the fabric layer (14b) and is designed to isolate the belt body from the fabric layer (14b).

The present invention relates to a belt according to the preamble of claim 1.

In drive technology, belts are used for force transmission in various technical fields. For force transmission, e.g. in an internal combustion engine, a belt may be configured as a flexible, endless closed strip. Belts may however also be used with two open ends, for example in elevator systems in order to move an elevator car in height.

Such belts are today normally made substantially from a flexible material, for example an elastomer material, e.g. rubber, or e.g. a plastic such as polyurethane (abbreviated to: PU) as belt bodies in which tensioning members e.g. steel cables or textile tensioning members are embedded in the direction of force transmission, i.e. in the movement direction. The belt has at least one profiled side which, during use, is in contact with at least one drive roller and at least one deflection roller. The belt may thereby be driven and at the same time guided. Depending on application, the profiling may be formed transversely to the movement direction e.g. as teeth, or in the movement direction e.g. as wedges or as ribbing.

In order to protect the material of the belt body from abrasion and similar, it is known to provide a coating at least on the profiled side of the belt. Here for example a fabric may be used which is placed with one of its sides superficially on the corresponding side of the belt body. On the opposite side facing towards the outside, the fabric may be additionally covered with a film. Thus, the outside of the profiling may have the film facing towards the outside.

The fabric may have good stretching properties in the movement direction, so that the elasticity of the belt body is not or at least not significantly restricted, while the fabric may however counter an abrasion of this side of the belt body. This may lead to a reduction in wear and lower noise. The outermost film may protect the fabric e.g. from the penetration of moisture.

Normally, such a belt is produced in that the coating is produced separately as a laminate and then connected to the belt body. The fabric is thus lined with the film to form a laminate. The laminate is then preformed so that the laminate assumes the contour of the belt profiling. The film is plasticized, deformed and hardened again by cooling. Thus, the fabric assumes the preset form of the profiling. The preformed laminate is then used in production of the belt so that the film forms the outside of the belt profiling.

The disadvantage here is that moisture can penetrate into the coating and into the belt body through fault points on the film caused by wear or mechanical damage to the film. If steel cables are used as tensioning members, the moisture can lead to corrosion there. In the case of textile tensioning members, the moisture may have a negative effect on the adhesion to the material of the belt body.

WO 2017 178 123 A1 describes a toothed belt, preferably a polyurethane toothed belt (PU toothed belt) which has at least one drive side provided with a tooth profile, wherein the tooth profile has been provided with a fabric layer on the outside. On its outside facing away from the tooth profile, the fabric layer has a coating consisting of plastic, preferably polyethylene (PE), wherein in relation to its thickness, on one side, on its side facing the tooth profile, the fabric layer has been penetrated at least partly by base material of the toothed belt and at least partly on its outside by the polymer coating, in such a way that the fabric layer is free of penetration material in a thickness region lying on the inside relative to its thickness. The outer plastic coating may avoid an unacceptably great penetration of the fabric by the material of the toothed belt body, e.g. the polyurethane, which could lead to a shift or distortion of the fabric structure. The stretching capacity of the fabric and hence the tooth load-bearing capacity may thereby be negatively affected.

The disadvantage with such belts, e.g. the toothed belt from WO 2017 178 123 A1, is that moisture can reach behind the outer film from the side and penetrate the fabric layer. The moisture can thus propagate into the fabric layer in the transverse direction as far as regions in which the steel cables or textile tensioning members run, which may then be attacked by moisture and e.g. can corrode.

No moisture can penetrate from the fabric layer to the steel cables or textile tensioning members as tensioning members, since the steel cables or textile tensioning members are completely sheathed by the flexible material of the belt and are thus isolated from and protected against moisture. This may be achieved in that the tensioning members are firstly sheathed by the flexible material and then inlaid into the preformed laminate.

In production, the sheathed tensioning members are however guided over rollers directly after sheathing with the flexible material. If the surrounding flexible material has not hardened adequately by this time, the flexible material may be pushed aside by contact with the roller. Thus, the sheathing may not only be radially thinner at these points but the flexible material may even be pushed aside so far that the sheathing is interrupted and the tensioning member may become visible on the outside at this fault point.

If a tensioning member with such fault points is inlaid into the preformed laminate, the fault points may be facing towards the laminate. Thus, the tensioning member may come into direct contact with the fabric layer at the fault point. Moisture penetrating into the fabric layer may in this case reach the tensioning members via the fault points in the sheathing, and in the case of steel cables used as tensioning members, can damage or weaken these by corrosion. In the case of textile tensioning members, these may swell at least at the fault points. In any case, the load-bearing capacity of the tensioning members and hence the belt may be reduced. This may also apply to the service life of the belt. In particular when belts are used in applications such as e.g. in the sector of offshore wind turbines which are exposed to salty marine air, the penetration of saline moisture into the belt as far as its tensioning members may lead to the above disadvantages.

An object of the present invention is to provide a belt of the type described initially such that the above-mentioned disadvantages can be avoided or at least reduced. In particular, the intention is to provide a belt in which the penetration of moisture via the fabric layer to the tensioning members can be avoided or at least reduced. It is at least intended to provide an alternative to such known belts.

The object is achieved according to the invention by a belt having the features claimed in claim 1. Advantageous developments are described in the dependent claims.

The present invention thus concerns a belt with a belt body which extends substantially in a longitudinal direction and substantially comprises a flexible material, wherein at least one tensioning member, preferably a plurality of tensioning members, is at least substantially embedded in the belt body in the longitudinal direction and at least substantially surrounded by the flexible material of the belt body, and with a coating which is arranged directly on the belt body from a drive side of the belt, wherein the coating comprises a fabric layer.

Such belts were described at the outset. The problem may arise here that, for production reasons, the tensioning members are not embedded in the flexible material of the belt body completely as desired, and are not completely surrounded by the flexible material of the belt body, but fault points are formed in the sheathing at which the tensioning member penetrates the sheathing and thus becomes visible on the outside. At the fault points, this may lead to direct contact with the coating comprising the fabric layer which was previously the layer lying directly on the encased tensioning member. Moisture penetrating into the fabric layer may in this case reach the tensioning member via the fault points in the sheathing, and damage or weaken this. The fabric layer may also be referred to as a woven ply.

The present invention is characterized in that facing the belt body, the coating has a first film which is arranged between the belt body and the fabric layer and is designed to isolate the belt body from the fabric layer. A film means in particular a very thin layer of a material.

In this way, a material which can separate the tensioning member and the fabric layer from each other may be provided on the side of the coating, so that a superficially complete covering of the fabric layer by the first film may be achieved. In particular, the first film with the fabric layer may, as described above, be formed as a laminate, which can simplify the production of such a coating and/or ensure the superficially complete covering of the fabric layer by the first film. The first film may thus also be present at the above-mentioned fault points in the sheathing of the tensioning member, and isolate the fault points from the fabric layer so that, although moisture can penetrate into the fabric layer and propagate there, it can no longer reach the tensioning member via the fault points. This can reduce or completely avoid the damage described initially. In other words, by means of the first film, the belt body is isolated, protected, screened etc. from the fabric layer. This may in particular apply to a transfer of moisture from the fabric layer to the steel cable.

For this, using a first film as a very thin layer may have the advantage of achieving the above-mentioned purpose and at the same time ensuring that the increase in thickness, cost and/or weight of the coating is kept to a minimum.

According to one aspect of the present invention, the flexible material of the belt body comprises polyurethane, preferably consists of polyurethane, and the material of the first film comprises polyurethane, preferably consists of polyurethane. In this way, the mechanically advantageous properties of polyurethane may be used for a belt according to the invention.

According to a further aspect of the present invention, the flexible material of the belt body and the material of the first film comprise the same polyurethane, preferably consist of the same polyurethane. Thus, the use of different materials at this point on the belt, which could lead to different material properties, can be avoided. Also, the use of different materials may increase production costs. In particular, it is an aspect of the present invention to ensure that only material intended to surround the tensioning member is present against the fabric layer. This may be achieved by the use of the same material as a flexible material of the belt body and as the material of the first film.

According to a further aspect of the present invention, the material of the fabric layer comprises polyamide, preferably consists of polyamide. In this way, the mechanically advantageous properties of polyamide may be used for a belt according to the invention. In particular, the comparatively high abrasion resistance and the comparatively low coefficient of friction of polyamide are advantageous for a belt if the polyamide fabric layer is used directly as the outermost layer, or at least in portions becomes the outermost layer by removal of a layer lying above e.g. a film, during operation.

According to a further aspect of the present invention, the first film is arranged directly adjacent to the fabric layer. In this way e.g. the moisture-screening effect of the first film can be achieved as closely as possible to the fabric layer which can conduct moisture. Thus, the layers and bodies arranged facing away from the fabric layer relative to the first film may e.g. be protected from moisture. Furthermore, the number of layers may be kept low. This may save or reduce costs with regard to material usage and production steps, and save or reduce weight and installation space.

According to a further aspect of the present invention, the coating furthermore comprises a second film arranged facing away from the first film relative to the fabric layer, and formed so as to cover the fabric layer towards the outside. In this way, the fabric layer may be protected in this direction from external influences such as e.g. moisture, contamination and similar. If the second film constitutes the outside of the belt on this side, the friction relative to other bodies may be determined by the second film instead of by the fabric layer. The fabric layer can also be mechanically protected by the second film in order e.g. to reduce abrasion.

According to a further aspect of the present invention, the second film comprises polyurethane, preferably consists of polyurethane. In this way, the mechanically advantageous properties of polyurethane may be used for a belt according to the invention. The comparatively high coefficient of friction of polyurethane is acceptable here, since the second film as the outermost layer may in some cases abrade at least in portions during operation and hence the coefficient of friction is reduced.

According to a further aspect of the present invention, the second film comprises polyethylene, preferably consists of polyethylene. In this way, the mechanically advantageous properties of polyethylene may be used for a belt according to the invention.

According to a further aspect of the present invention, the second film is arranged directly adjacent to the fabric layer. This allows the number of layers to be kept low. This may save or reduce costs with regard to material usage and production steps, and save or reduce weight and installation space.

According to a further aspect of the present invention, the drive side of the belt has a profiling, preferably wedges oriented in the transverse direction. This may improve a mechanical contact with other bodies via the drive side of the belt so that higher forces can be transmitted in the longitudinal direction of the belt. This may be achieved particularly effectively by wedges oriented in the transverse direction, i.e. by forming the belt according to the invention as a toothed belt.

Two exemplary embodiments and further advantages of the invention will be discussed below in conjunction with the following figures. The drawing shows:

FIG. 1 a schematic longitudinal section through a belt;

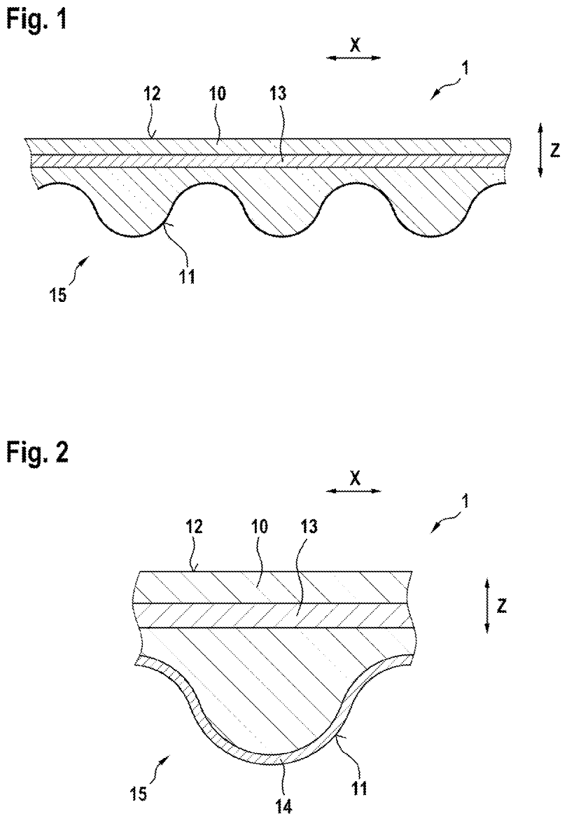

FIG. 2 an illustration of a detail of FIG. 1;

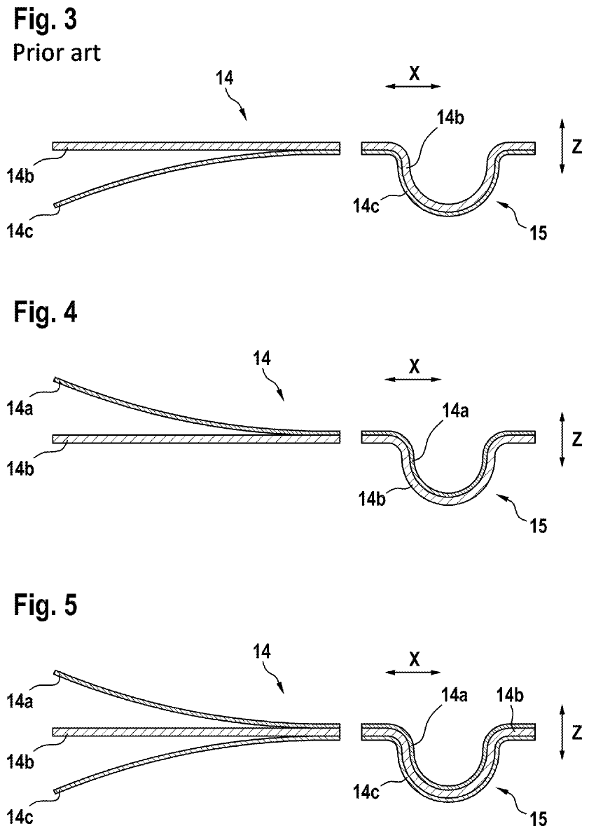

FIG. 3 a known two-layer structure of a known belt;

FIG. 4 a two-layer structure according to the invention of a belt according to the invention in a first exemplary embodiment; and

FIG. 5 a three-layer structure according to the invention of a belt according to the invention in a second exemplary embodiment.

The description of the above-mentioned figures is given in Cartesian coordinates with a longitudinal direction X, a transverse direction oriented perpendicularly to the longitudinal direction X, and a vertical direction Z oriented perpendicularly both to the longitudinal direction X and also to the transverse direction. The longitudinal direction X may also be referred to as the depth X, the transverse direction as the width, and the vertical direction Z as the height Z.

FIG. 1 shows a schematic longitudinal section through a belt 1. FIG. 2 shows an illustration of a detail of FIG. 1.

The belt 1 represents a generally known belt 1 configured as a toothed belt 1. The toothed belt 1 has a belt body 10 which consists of polyurethane (PU). The toothed belt 1 has a first belt side 11 formed as a drive side 11, in order to cooperate with drive rollers, guide rollers and deflection rollers (not shown) of a drive system and to transmit forces. For this, the drive side 11 has a profiling 15 in the form of teeth 15. Opposite the drive side 11 in height Z, the toothed belt 1 has a second belt side 12. Several tensioning members 13 are arranged inside the belt body 10 in the form of steel cables 13 running in the longitudinal direction X and formed from individual steel strands. The steel cables 13 serve to transmit tension forces in the longitudinal direction X as the movement direction of the toothed belt 1.

The outer surface of the drive side 11 of the toothed belt 1 is formed by a coating 14 which is produced separately as a laminate. The belt body 10 and steel cables 13 embedded therein are applied to the laminated coating 14 and hardened, so that a substance-bonded connection forms between the laminated coating 14 and the belt body 10, leading to an integral toothed belt 1, see for example FIG. 2.

FIG. 3 shows a known two-layer structure of a known belt 1 such as the toothed belt 1 described above. A fabric layer 14b and a film 14c as an outer film 14c are used, which are produced separately and combined into a two-layer structure by being laid one on top of the other. The two-layer structure is then brought into the desired form corresponding to the arrangement of the profiling 15.

Such coatings 14 for toothed belts 1 are known. In this case, the fabric layer 14b directly adjoins the belt body 10 so that a direct contact can occur between the steel cables 13 and the fabric layer 14b if the material of the belt body 10 is unintentionally penetrated by a steel cable 13 at fault points. This direct contact between the fabric layer 14b and the steel cables 13 may allow moisture, which can enter the fabric layer 14b from the side in the transverse direction and propagate further inward in the transverse direction inside the fabric layer 14b, to also reach the fault points and attack and damage the steel cables 13 there e.g. by corrosion.

FIG. 4 shows a two-layer structure according to the invention of a belt 1 according to the invention, such as the toothed belt 1 described above, in a first exemplary embodiment. In order to avoid the above-mentioned contact between the steel cables 13 and the coating 14 at the fault points, in this exemplary embodiment the coating 14 comprises not only the above-mentioned fabric layer 14b but also a first film 14a as an inner film 14a which is arranged between the fabric layer 14b and the belt body 10 or steel cables 13. The inner film 14a thus lies between the steel cables 13 and fabric layer 14a even at the fault points, so that even on occurrence of undesirable fault points, direct contact between the steel cables 13 and fabric layer 14b can be avoided. This may prevent the transfer of moisture from the fabric layer 14b to the steel cables 13, and hence this cause of the generation of corrosion of steel cables 13 may be excluded.

The belt body 10 and the inner film 14a here comprise the same material, e.g. polyurethane (PU), so that the previously described effect may be achieved without changing the material properties in the region between the fabric layer 14b and the belt body 10. The fabric layer 14b may preferably be made from polyamide (PA).

FIG. 5 shows a three-layer structure according to the invention of a belt 1 according to the invention, such as the toothed belt 1 described above, in a second exemplary embodiment. The toothed belt 1 according to the second exemplary embodiment corresponds to the toothed belt 1 of the first exemplary embodiment, with the difference that the coating 14 has a second film 14c as an outer film 14c pointing towards the outside of the belt body 10. This allows protection of the fabric layer 14b on the outside towards the drive side 11. The outer film 14c may consist of polyurethane (PU) or of polyethylene (PE).

### LIST OF REFERENCE SIGNS (PART OF THE DESCRIPTION)

X Longitudinal direction

Y Transverse direction; width

Z Vertical direction; height

1 Belt; toothed belt

10 (PU) belt body

11 First belt side; drive side

12 Second belt side

13 Tensioning member; steel cables

14 Coating

14a First (PU) film; (PU) inner film

14b (PA) fabric layer

14c Second (PE/PU) film; (PE/PU) outer film

15 Profiling or teeth of first belt side 11

1.-10. (canceled)

11. A belt comprising a belt body which extends substantially in a longitudinal direction and substantially comprises a flexible material;
wherein at least one tensioning member is at least substantially embedded in the belt body in the longitudinal direction and the at least one tensioning member is at least substantially surrounded by the flexible material of the belt body;
wherein a coating is arranged directly on the belt body from a drive side of the belt, and wherein the coating comprises a fabric layer; and,
wherein facing the belt body, the coating has a first film which is arranged between the belt body and the fabric layer and is designed to isolate the belt body from the fabric layer.

12. The belt as claimed in claim 11, wherein the at least one tensioning member is a plurality of tensioning members.

13. The belt as claimed in claim 11, wherein the flexible material of the belt body comprises polyurethane, and wherein the material of the first film comprises polyurethane.

14. The belt as claimed in claim 13, wherein the flexible material of the belt body and the material of the first film comprise the same polyurethane.

15. The belt as claimed in claim 13, wherein the flexible material of the belt body and the material of the first film consist of the same polyurethane.

16. The belt as claimed in claim 11, wherein the flexible material of the belt body consists of polyurethane, and wherein the material of the first film consists of polyurethane.

17. The belt as claimed in claim 16, wherein the flexible material of the belt body and the material of the first film consist of the same polyurethane.

18. The belt as claimed in claim 11, wherein the material of the fabric layer comprises polyamide.

19. The belt as claimed in claim 11, wherein the material of the fabric layer consists of polyamide.

20. The belt as claimed in claim 11, wherein the first film is arranged directly adjacent to the fabric layer.

21. The belt as claimed in claim 11, wherein the coating further comprises a second film which is arranged facing away from the first film relative to the fabric layer, and is configured to cover the fabric layer towards the outside.

22. The belt as claimed in claim 21, wherein the second film comprises polyurethane.

23. The belt as claimed in claim 21, wherein the second film consists of polyurethane.

24. The belt as claimed in claim 21, wherein the second film comprises polyethylene.

25. The belt as claimed in claim 21, wherein the second film consists of polyethylene.

26. The belt as claimed in claim 21, wherein the second film is arranged directly adjacent to the fabric layer.

27. The belt as claimed in claim 11, wherein the drive side of the belt has a profiling oriented in a direction transverse to a movement direction of the belt.

28. The belt as claimed in claim 27, wherein the profiling is teeth oriented in the direction transverse to a movement direction of the belt.

29. The belt as claimed in claim 11, wherein the drive side of the belt has a profiling oriented in a movement direction of the belt.

30. The belt as claimed in claim 29, wherein the profiling is ribbing oriented in the movement direction of the belt.
